(19) United States
(12) Patent Application Publication
(10) Pub. No.: US 2008/0061146 A1
(43) Pub. Date: Mar. 13, 2008

(54) Barcode image generating device, barcode image reading device and barcode image generating and reading system

(75) Inventor: Yoshio Komaki, Nishinomiya-shi (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES, INC.

(21) Appl. No.: 11/899,734

(22) Filed: Sep. 7, 2007

(30) Foreign Application Priority Data
Sep. 13, 2006 (JP) 2006-247800

(51) Int. Cl. G06K 7/10; G06K 19/06

(52) U.S. Cl. 235/462.41; 235/494

(57) ABSTRACT

A barcode image generating device including:
a barcode image generating section for generating a barcode image based on content;
an ID assigning section for assigning a content ID to the content based on the content;
a machine reading specifications determining section for determining, based on the content ID, the machine reading specifications that is readable by the machine; and
a visual expression specifications determining section for determining, based on the content ID, visual expression specifications of the barcode image that is visually readable,
wherein the barcode image generating section generates the barcode image based on the machine reading specifications and the visual expression specifications.

### RELATED APPLICATION

This application is based on Japanese Patent Application No. 2006-247800 filed on Sep. 13, 2006 in Japanese Patent Office, the entire content of which is hereby incorporated by reference.

### TECHNICAL FIELD

The present invention relates to a barcode image generating device which generates barcode images including information in image patterns, a barcode image reading device which read information from the barcode image, and a barcode image generation and reading system.

### BACKGROUND

Conventionally, barcodes have been widely used in which band pattern images of bars (black lines) and spaces (white or background color) are caused to correspond with numerals, text or symbols and by substitution, it becomes possible for a machine to read information from a pattern image.

By printing the barcode on paper, plastic or other mediums, it becomes possible to accurately enter information to be read by a machine such as identification numbers or order numbers or the like without using much time. An example of such a barcode is shown in FIG. 14(a) and FIG. 14(b). FIG. 14(a) is a barcode with the common bar and space pattern, while FIG. 14(b) is the two-dimensional barcode which has become widely used in recent years.

The use of these conventional barcodes has expanded from use inside factories which was the initial intended use to use in printed matters, websites, tickets, product packages, cell phone images, TV images and the like, and to use in a form in which they are included in a portion of the image that is meaningful to the user. FIG. 14(c) shows an example of a printed barcode appended to text image and FIG. 14(d) shows an example of a cell phone display of an input image.

By placing the barcode image on a portion of a produce or image or the like that is meaningful to the user, the barcode may be used in a wide range of applications since the user may refer to related information via the Web or easily input telephone numbers or addresses such as a Uniform Resource Locator (URL) addresses using a device such as a cell phone that has barcode reading functions.

However, assuming that the barcode is used in these manners, the user must identify the barcode image and actively read the barcode image. However, the conventional barcode image itself is not considered as a subject perceptible to human beings, and does not make sense to humans and it is difficult to identify it. The user is aware that it is a barcode, but it is impossible to distinguish the contents of the barcode and so the only alternative is to rely on machine reading. In some cases, the content that is read is different from the expected content, and sometimes it becomes clear that the operation was useless after it has been performed.

As a result, as shown in FIG. 14(e), a barcode is known in which a text row of numbers or alphabet characters and the like which correspond to the barcode image such that the content of the barcode can be recognized by the user are placed below the barcode image. However, in this type of text row, there is an extremely large amount of information, and in addition, the visual correlation with the barcode image is poor and furthermore, this was not effective for the user to distinguish the content because at times it could not be read by the machine or because consistency could not be checked at the time of reading.

In order to solve the foregoing problems, technology has been developed in which an expression that can be perceived visually is provided. (See Patent Document 1 for example).

In Patent Document 1, technology is provided in which a color barcode is used and information is read by the color arrangement of the colors in the cell that comprise the barcode image. In this type of system, once color arrangement is ensured for each of the cells required for reading, the color, shape, size, background color and the like may be freely designed and it becomes possible to realize a meaningful barcode image form that is visually perceptible by the user.

An example of the color barcode is shown in FIG. 15. The color barcode is formed from a 5×5 cell and the actual color arrangement of each cell has 4 colors R, G, B, Bk (red, green, blue, black) as shown in portion A of FIG. 15. For example, the size and shape are changed and the like, and thereby made into a shape where the entire image is visually meaningful for human while maintaining machine reading properties.

However, there were no simple methods for suitably setting the visual expression of the barcode in this manner based on the content shown by the barcode. The design of the color barcode is not performed in a specified way, and in the present situation, it is performed using many manual man-hours in some cases. For this reason, the visual expression of the color barcode was not directly related to the content shown by the barcode of the corporate logo design or the like, and a small number of fixed designs were often used.

Thus a device or method in which the visual expression of the color barcode which can be made relevant to content shown by the barcode and can be simply formed as a barcode image was required.

[Patent Document 1] Unexamined Japanese Patent Application Publication No. 3336311

As described above, by including a visual expression in the barcode image, the user can anticipate the result of the reading and this provides a sense of assurance, but there were no methods or devices for simply designing a suitable visual expression in the content shown by the barcode.

### SUMMARY

The present invention was conceived in view of the above problems and the object thereof is to provide a barcode image generating device which is capable of simply generating a barcode image that includes a suitable visual expression based on the content shown by the barcode; a barcode image reading device which is capable of reading the content shown by the barcode from the barcode image that includes the visual expression; and a barcode image generating and reading system.

The above object is achieved by the following inventions.

A barcode image generating device comprising:

a barcode image generating section for generating a barcode image based on content;

an ID assigning section for assigning a content ID to the content based on the content;

a machine reading specifications determining section for determining, based on the content ID, the machine reading specifications of the barcode image that is readable by the machine; and

a visual expression specifications determining section for determining, based on the content ID, visual expression specifications of the barcode image that is visually readable,

wherein the barcode image generating section generates the barcode image based on the machine reading specifications and the visual expression specifications.

A barcode image reading device comprising:

an ID reading section for reading a content ID from the barcode image generated based on the content ID, wherein the barcode image has an expression pattern as visual expression specifications in which a portion of the content ID is readable by viewing;

an ID portion reading section which reads a portion of the content ID from the expression pattern; and

an ID verifying section which verifies the content ID that was read by the ID reading section and a portion of the content ID that was read by the ID portion reading section and outputs a warning based on the results of the verification.

### BRIEF DESCRIPTION OF THE DRAWINGS

FIG. 1 is a block diagram showing the structure of the barcode image generating and reading system of the present invention.

FIG. 2 is a flowchart showing the flow of operations in the content registration section.

FIG. 3 shows the content ID structure.

FIG. 4 shows the arrangement of the visual expression specifications in the content ID.

FIG. 5 is a pattern diagram showing the flow in which the print output which includes the barcode image is generated.

FIG. 6 shows the flow of the mapping of the visual expression specifications.

FIG. 7 shows the visual expression specifications data and the barcode image of Embodiment 1.

FIG. 8 shows the barcode image of another example of Embodiment 1.

FIG. 9 is a flowchart showing the flow of the operation of the content retrieving section.

FIG. 10 shows the barcode image of another example of Embodiment 1.

FIG. 11 shows the barcode image of Embodiment 2.

FIG. 12 is a block diagram showing the schematic structure according to Embodiment 2 of the barcode image reading device of the present invention.

FIG. 13 shows a barcode image according to another example of Embodiment 2.

FIG. 14 shows a barcode image of the prior art.

FIG. 15 shows a barcode image of the prior art.

### PREFERRED EMBODIMENTS OF THE INVENTION

The barcode image generating device, the barcode image reading device and the barcode image generating and reading system of the present invention will be describe based on the drawings. It is to be noted that the present invention will be described based on the embodiments in the drawings but the present invention is not to be limited by these embodiments.

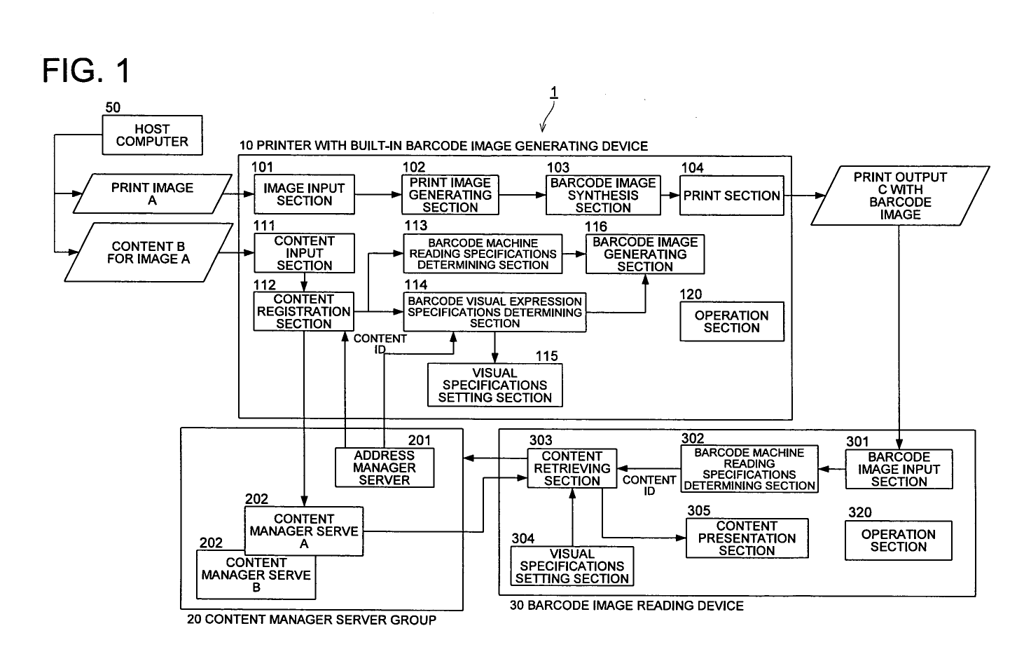

First, the schematic structure of the barcode image generating and reading system 1 will be described. FIG. 1 is a block diagram showing the structure of the barcode image generating and reading system 1.

As shown in FIG. 1, the barcode image generating and reading system 1 comprises a printer with built-in barcode image generating device 10 that includes the barcode image generating device; the barcode image reading device 30; content management server group 20; and a host computer 50 and the like.

At the printer with built-in barcode image generating device 10, the print image A for print output from the printer and content B which is related to the print image A are input from the host computer 50, and the input content B is registered at the content manager server group 20 and the content ID corresponding to content B is retrieved from the content manager server group 20. A barcode image that is readable by machine and user sight is then generated and the generated barcode image is combined with a portion of the print image A and the print output C including a barcode image is output.

The barcode image reading device 30 allows input of print output C including a barcode image and the content ID is read from the print output C including a barcode image. Content B which corresponds with the content ID from the content manager server group 20 is then retrieved based on the content ID that was read and provided for the user.

Schematic descriptions of the barcode image generating and reading system 1 was given above, but in all of these, a basic flow is achieved in which a barcode image corresponding to content is generated and the barcode ID is obtained by reading them and the corresponding content itself can be accessed.

For this purpose, it is sufficient to simply read the content ID from the barcode image, but in this embodiment, the barcode image itself has a visual expression and because the user can visually recognize the features of the corresponding content, prediction with respect to the content obtained can be done in advance to some extent, and thus barcode reading can be performed with a sense of assurance. Also in some cases, the reading may be omitted when the reading is not carried out for an intended purpose thereby eliminating workload.

The following is a detailed description of the printer with built-in barcode image generating device 10, the barcode content management server group 20, and the barcode image reading device 30.

### Embodiment 1

First, the structure of the printer with built-in barcode image generating device 10 will be described using FIG. 1.

As shown in FIG. 1, the printer with built-in barcode image generating device 10 comprises: an image input section 101; a print image generating section 102; a barcode image synthesis section 103; a print section 104; a content input section 111; a content registration section 112; a barcode machine reading specifications determining section 113; a barcode visual expression specifications determining section 114; a visual specifications setting section 115; a barcode image generating section 116 and an operation section 120 and the like.

The image input section 101 allows input of print image A from the host computer 50. The print image A is the image which will be printed out and various formats can be used by commonly used printers are possible. The barcode image is combined with a portion of the print output to the medium for this image A.

The print image generating section 102 converts the print image A of the various formats that were input at the image input section 101 into print image data. For example, CMYK binary image data is generated with a suitable resolution for the print section 104 that is described hereinafter.

The barcode image synthesis section 103 combines the barcode image generated at the barcode image generating section 116 with the print image data generated at the print image data generating section 102.

The print section 104 prints the print image in which the barcode image is combined at the barcode image synthesis section 103 on a recording medium such as paper and the like.

The content input section 111 inputs content B which is related to print image A from the host computer 50.

The content registration section 112 is equivalent to the ID assigning section of the present invention and the content B that is input at the content input section 111 is registered at the content manager server group 20. The content ID corresponding to the registered content B is obtained from the content server group 20.

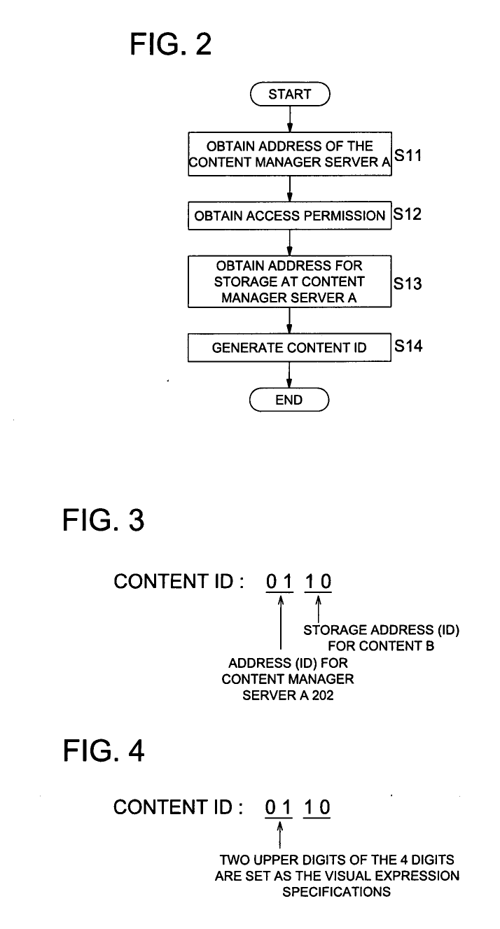

The details of the operation performed at the content registration section 112 is described here FIG. 2. FIG. 2 is a flowchart showing the flow of operations performed the content registration section 112.

In Step S11, the content registration section 112 performs inquiries for the address management server 201 and obtains the address of the content manager server 202. At this time, by sending the account name input from the operation section 120 or the host computer 50 to the address management server 201 the content manager server 202 corresponding to the account name is selected. Here the content manager server A202 is selected and the two digit value such as “01” which is the address corresponding to the content manager server A202 is sent back to the content registration section 112 as the ID.

In Step S12, the content registration section 112, the address sent back from the address management server 201 is used to obtain access permission for performing the inquiry at the content manager server A202. At this time, the account name and password input from the operation section 120 or the host computer 50 are sent to the content manager server A202.

In Step S13, the content registration section 112 sends the content B to the content manager server A202. The content B is stored in the empty region of the content manager server A202 and the two digit value such as “10” which shows the destination address for storage is sent back to the content registration section 112 as the ID.

In Step S14, the content registration section 112 combines the ID obtained from the address management server 201 and the content manager server A202 and thereby generates the content ID. In this case, as shown in FIG. 3, the four digit value “0110” which has the two digit value “01” which is the ID for the content manager server A202 as the upper digits, and the two lower digit value “10” a which is the ID for the storage destination of content B in the content manager server A as the lower digits, is generated as the content ID.

Returning to FIG. 1, it can be seen that the barcode machine reading specifications determining section 113 is equivalent to the machine reading specifications determining section of the present invention and the machine reading specifications of the barcode image that is readable by the machine is determined based on the content ID generated at the content registration section 112.

The barcode visual expression specifications determining section 114 is equivalent to the visual expression specifications determining section of the present invention and a portion is fetched from the content ID that is generated at the content registration section 112 in accordance with the specifications data that is obtained from the visual specifications setting section 115 and the visual expression specifications of the barcode image for which the inquiry was made at the address management server 201 and which corresponds to a portion of the content ID is read, and the visual expression specifications of the barcode image is determined.

The visual specifications setting section 115 specifies from which number comprising the content ID for the barcode visual expression specifications determining section 114, the visual expression specifications of the barcode image will be determined. In this case, as shown in FIG. 4, of the 4-digit value “0110” which shows the content ID, the two upper digits “01” corresponding to the ID of the barcode content manager server A202 are specified.

The barcode image generating section 116 generates the barcode image based on the specifications of the barcode machine reading specifications determining section 113 and the barcode visual expression specifications determining section 114 respectively.

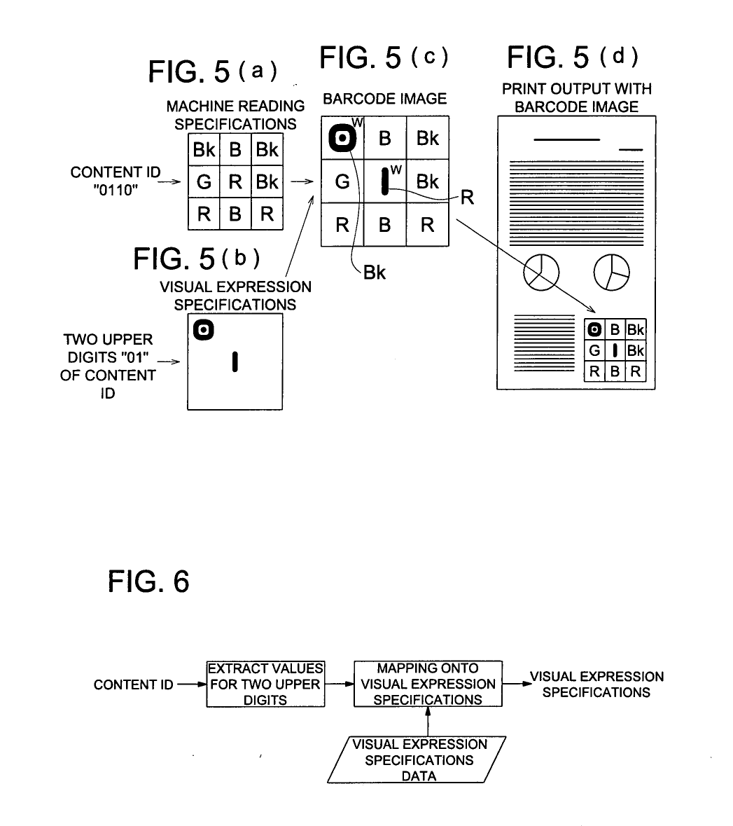

The barcode image generating in the barcode image generating section 116 is described using FIG. 5. FIG. 5 is a pattern diagram showing the flow in which the barcode image is generated.

The visual expression specifications specifies the configuration of the cell (alphabet display or chart display), the pattern (including text), the size, the background image and the like, and thus it becomes possible the user to guess a portion of the content ID by sight. In this embodiment, as shown in FIG. 5 (a), the machine reading specifications is a 3×3 barcode in which four color cells R, G, B and Bk (red, green, blue and black) are used. Also, as shown in FIG. 5(b), the cell configuration is used as visual expression specifications. In this case, if color remains in the center portion of the cell and a fixed area (for example 40%) of the total area of the cell, because machine reading is possible, the user adjusts the cell configuration so as to be meaningful, within that range. This depends on the color zip specifications.

As shown in FIG. 5(c), the barcode image generating section 116 generates barcode images based on the respective images expressed by these types of machine reading specifications and visual expression specifications. It is to be noted that the visual expression specifications of the barcode image uses the values for the two upper digits of the content ID and are mapped as shown in FIG. 6. In this manner, the barcode machine reading specifications determining section 113, the barcode visual expression specifications determining section 114, and the barcode image generating section 116 are equivalent to the barcode image generating section in the present invention.

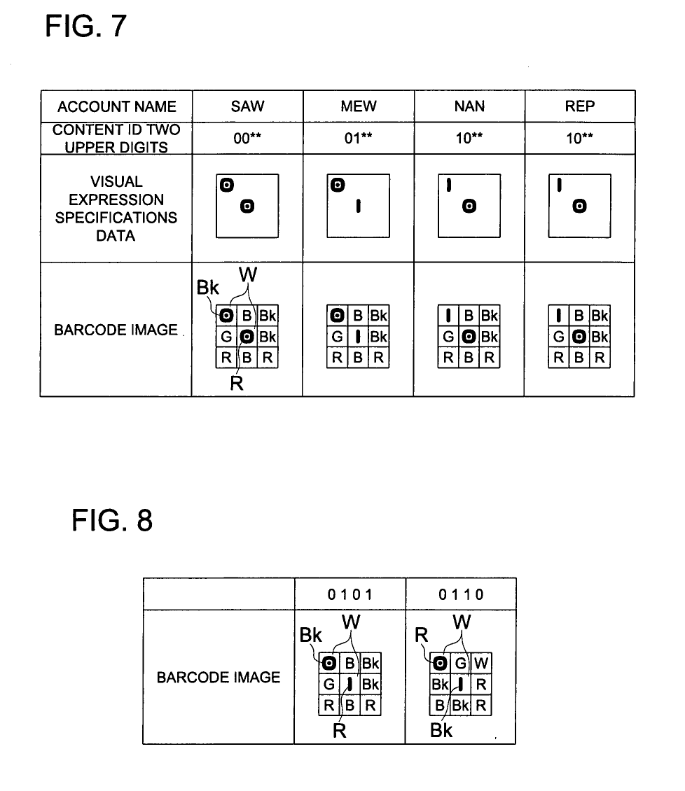

Next, the visual expression specifications data and the corresponding barcode image will be described using FIG. 7. FIG. 7 shows an example the visual expression specifications data and the corresponding barcode image.

As shown in FIG. 7, the visual expression specifications data is the black and white bit map image corresponding to the values of the two upper digits of the content ID, and by combining this with the image which expresses the machine reading specifications of the aforementioned barcode, the barcode image is generated. It is to be noted that the visual expression specifications are the same, and an example of the case in which the machine reading specifications are different is shown in FIG. 8.

Returning to FIG. 1 shows that the operation section 120 includes a display and various operation keys that are not shown, and thus the user may participate in control of the device. For example, the barcode image generated at the printer with built-in barcode image generating device 10 can be displayed at the display and key input which indicate confirmation from the user is received and printing out may be done.

Next, the structure of the content manager server group 20 will be described using FIG. 1.

As shown in FIG. 1, the content manager server group 20 comprises the address manager server 201 and a plurality of content manager servers 202.

The content manager server group 20 inputs content B from the printer with built-in barcode image generating device 10, and the content ID corresponding to the input content B is sent back. In addition, the content ID from the printer with built-in barcode image generating device 10 is input and the visual expression specifications data corresponding to the input content ID is sent back. The content ID from the barcode image reading device 30 is input and the content B corresponding to the input content ID is sent back.

The address manager server 201 can register the visual expression specifications data for the barcode image corresponding to the address and account name of the content manager server 202 corresponding to the account name and when the account name is input, the address of the corresponding content manager server 202 is read and sent back. Also, when the address of the content manager server 202 is input, the visual expression specifications data for the corresponding barcode image is read and sent back. It is to be noted that updating of the registration content is limited to a specific manager, but no limits are imposed on reading and any user may use the reading.

The content manager server 202 is capable of content B registration and reading. Account name and password verification is necessary for registration, but no limits are imposed on reading and any user may use the reading. At the time of content B registration, the ID is sent back and it becomes possible to read content B that has been registered, using the ID.

Next, the structure of the barcode image reading device 30 will be described using FIG. 1.

As shown in FIG. 30, the barcode image reading device 30 comprises a barcode image input section 301, a barcode machine reading specifications determining section 302; a content retrieving section 303, a visual specifications setting section 304, a content presentation section 305, and an operation section 320.

The barcode image reading device 30 allows input of print output C including a barcode image and the content ID is read from the input print output C including a barcode image. The content B corresponding to the content ID from the content manager server group 20 is retrieved based on the content ID that was read and presented to the user.

The barcode image input section 301 reads the barcode image from the input print output C including a barcode image and obtains the barcode data from the barcode image.

The barcode machine reading specifications determining section 302 is equivalent to the ID reading section in the present invention and the content ID is determined by image data from the barcode image that was read at the barcode image input section 301.

The content retrieving section 303 fetches the content B with the content manager server 20 using the content determined at the barcode machine reading specifications determining section 302 and presents it at the content presentation section.

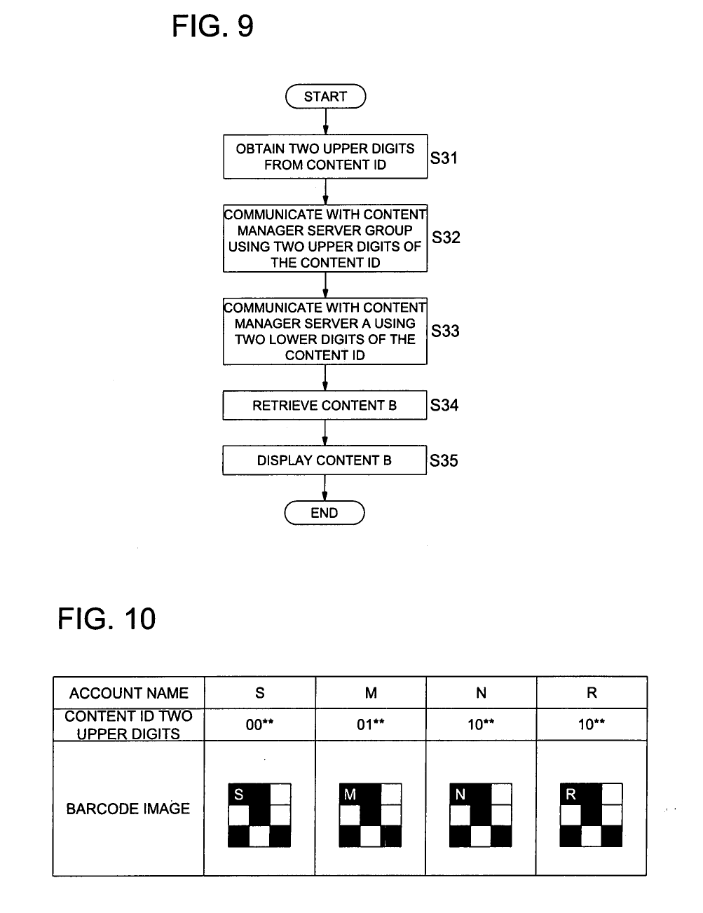

The details of the operations performed by the content retrieving section 303 will be described here using FIG. 9. FIG. 9 is a flowchart showing the flow of the operation performed at the content retrieving section 303.

At Step S31, the content retrieving section 303 fetches the value “01” which are the two upper digits corresponding to the visual expression specifications from “0110” which is the four digit value of the content ID that was determined at the barcode machine reading specifications determining section 302 in accordance with the setting of the visual specifications setting section 304.

In Step S32, an enquiry about the fetched value “01” was sent to the content manager server group 20 as the server address. The enquiry then arrives at the content manager server A202.

In Step S33, the content retrieving section 303, performs an inquiry using 2 lower digits “10” excluding the two upper values “01” which correspond to the visual expression specifications for the content ID in the four digit value “0110” of the content ID for the content manager server A202. At the time of the inquiry, confirmation can be obtained from the user via the operation section 320.

In Step S34, the content retrieving section 303 retrieves the content B corresponding to content ID “0110” from the content manager server A202.

In Step S35, the content presentation section 305 displays the content B that was retrieved by the content retrieving section 303 at the display of the operations section 320.

In this manner, according to the printer with built-in barcode image generating device 10 of the present invention, content ID is assigned according to the content B, and the visual expression specifications of the content ID are determined based on this, and by generating the barcode image in accordance with the visual expression specifications, a barcode image including a suitable visual expression in accordance to the content B can be simply generated.

That is to say, content B is stored in the content manager server 202 corresponding to that account name, and the content ID including the address of the content manager server 202 is used as the machine reading specifications of the barcode image and the address of the content manager server 202 corresponding to a portion of the content ID or the account name that is linked to the address of the content manager server 202 is used as the visual expression specifications. As a result, the user may make analogical inference for the main portion of the machine reading specifications of barcode image, the storage server for content B, and various information such as account name from limited information to which a visual expression of a 3×3 cell barcode image has been assigned. In addition, the content of the information with which the user may make an analogical inference using the barcode may be accessed quickly by omitting confirmation by the user using the operation section 120.

The barcode image reading device 30 of the present invention can read barcode images including a visual expression, and thus the user of the barcode image can observe the visual expression of the content ID that has been designed in the barcode image. As a result, it becomes possible to predict the results of reading the barcode image in advance, and the reading can be performed with a sense of assurance. Furthermore, waste of performing unnecessary, reading is eliminated and it becomes possible to access the necessary information with more certainty.

It is to be noted that in this embodiment, the content ID comprises values which have 4 digits, but content B may be stored on the internet and the URL may be the content ID. In this case, the URL includes a portion corresponding to the IP address of the server where content B is to be stored and the address manager server 201 uses the ID of the address manager server 201 as the server IP address.

In addition, in this embodiment, the barcode image has a 3×3 size, but it may be a large size which corresponds to the amount of information in the content ID. In this case, the size of the barcode image is set so that it can express the amount of information in the content ID and the amount of information in the visual expression portion of the content ID. Also, the configuration may be such that the size of the barcode image can be adjusted by the operation section 102.

Also, in this embodiment, the address manager server 201 sends back visual expression specifications data corresponding to a portion of the content ID and the visual expression specifications data is managed at the content manager server 202, but the visual expression specifications data may be provided in the printer with built-in barcode image generating device 10.

In addition, in this embodiment, the visual expression specifications is an expression in which the two upper digits of the content ID are shown directly, but provided that visual linkage to the content ID by the user is possible, any expression may be used and text, graphs or drawing that the user can identify may be used. Also the specifications for machine reading may be black and white.

In this embodiment, the content manager server 202 is assigned corresponding to the account name, and the address of the assigned content manager server 202 is caused to correspond with the visual expression specifications of the barcode image, but the account name for example, may be caused to correspond with the visual expression specifications of the barcode image. FIG. 10 shows an example of the barcode image the first character of the account name is in the upper left cell of the barcode image.

In this embodiment, visual expression specifications of the barcode image is a value of the two upper digits corresponding to the address of the content manager server 202, but other portions may be used provided that they are effective for barcode image reading. For example, a portion corresponding to the storage address of content B in the content manager server 202 may be used as the visual expression specifications of the barcode image and the content manager server 202 may present the address that was read using the control section 120, and confirmation by the user may be obtained.

### Embodiment 2

The printer with built-in barcode image generating device 10 according to Embodiment 2 is substantially the same as that of Embodiment 1 and thus detailed description thereof has been omitted, and only the barcode image specifications and barcode image reading device 31 which are different from those of Embodiment 2 will be described.

The barcode image according to Embodiment 1 displays one number or character using one cell configuration, but in the barcode image of Embodiment 2, visual expression is assigned to the barcode image using a plurality of cell colors.

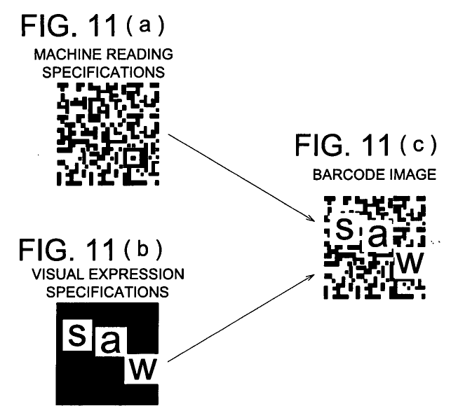

In this case, the barcode machine reading specifications determining section 113 makes the content ID into binary data, and machine determining specifications shown in FIG. 11(a) is output. At this time, the data is binary data in which error correction of the Reed-Solomon encoding and the like is possible. Furthermore, by performing data rearrangement in order to provide resistance to burst error, the setting is such that it is possible to read the same content ID for changes in the cell color of a portion that is 30% or less of the total area.

The barcode visual expression specifications determining section 114 reads the visual expression specifications data such as that shown in FIG. 11(b) that is stored in the address manager server 201. The visual expression specifications data designates the cell color for 30% or less of the area of the barcode image.

The barcode image generating section 116 combines the barcode machine reading specifications data with the visual expression specifications data and generates a barcode image such as that shown in FIG. 11(c). The synthesis process is performed by overwriting a fixed range of the barcode machine reading specifications data with the visual expression specifications data.

In this manner, the visual expression specifications of the barcode image is a combination of a plurality of cell colors at a specific position, and it is readable by machine at the barcode image reading device 31.

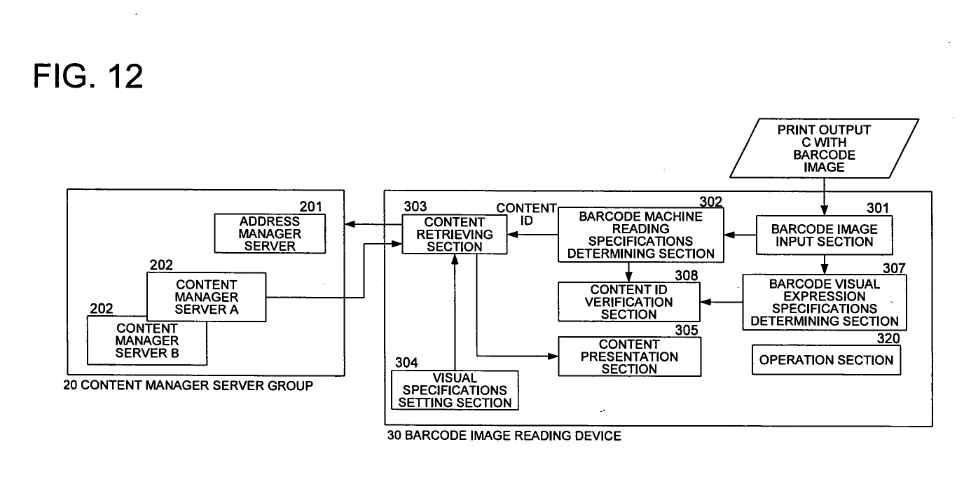

The structure of the barcode image reading device 31 according to Embodiment 2 will be described here using FIG. 12. FIG. 12 is a block diagram showing the structure of the barcode image reading device 31. It is to be noted that FIG. 12 also shows the content manager server group 20.

As shown in FIG. 12, barcode image reading device 31 comprises a barcode image input section 301, a barcode machine reading specifications determining section 302; a content retrieving section 303, a visual specifications setting section 304, a content presentation section 305; an operation section 320; a barcode visual expression specifications determining section 307 and content ID verification section 308. It is to be noted that the operations performed by the barcode image input section 301, the barcode machine reading specifications determining section 302, the content retrieving section 303, the visual specifications setting section 304, the content presentation section 305, and the operation section 320 are substantially the same as the operation of each part in the barcode image reading device 30 of Embodiment 1 which was described above and thus detailed descriptions thereof have been omitted.

The barcode visual expression specifications determining section 307 is equivalent to the ID section reading section of the present invention, and a portion corresponding to the visual expression specifications of the content ID can be estimated using the image data from the barcode image that was retrieved at the barcode image input section 301.

The content ID verification section 308 is equivalent to the ID verification section of the present invention, and a portion of the content ID retrieved by the barcode machine reading specifications determining section 302 and the barcode visual expression specifications determining section 307 respectively is verified and if there are any differences it is deemed an error and the reading operation is stopped and an error message is displayed at the operation section 320.

As a result, it becomes possible to detect an error generated in the visual expression of the barcode image due to an error or the like at the time of printing at the printer with built-in barcode image generating device 10, and thus the reliability of the barcode image is increased and reading can be performed with a sense of assurance.

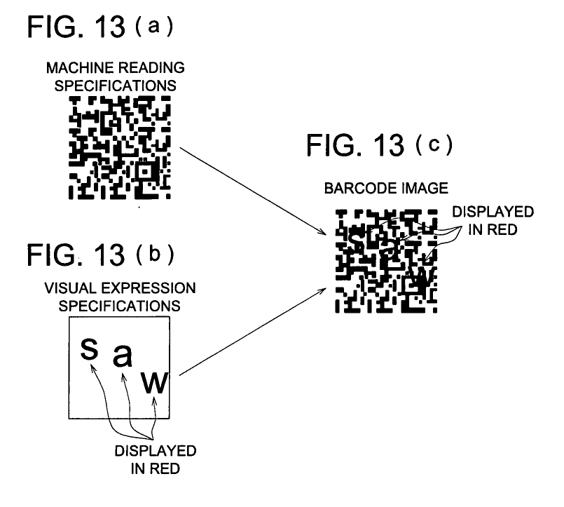

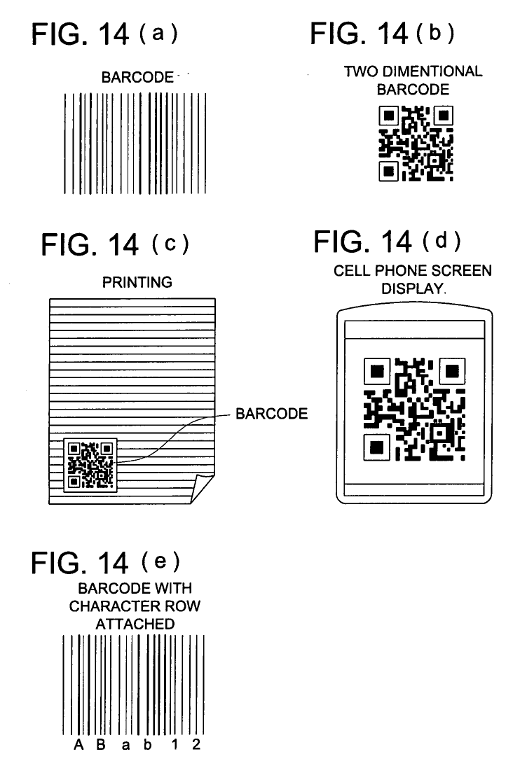

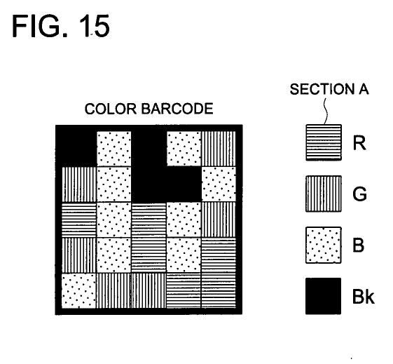

It is to be noted that in this embodiment, visual expression is provided on the barcode image overwriting a fixed range of the barcode machine reading specifications with the visual expression specifications data. However, the configuration may be such that by mixing the barcode machine determining shown in FIG. 13(a) using red visual expression specifications data for example that is shown in FIG. 13(b), the corresponding cell colors change to red as shown in FIG. 13(c). It is to be noted that in FIG. 13(c), the cell color corresponding to the visual expression specifications “s, a, w” shown in FIG. 13(b) are displayed as red. As a result, the number of cells that are changed can be reduced and it becomes possible to set the resistance to error in the barcode machine reading specifications determining section 113 to be low and the amount of information that becomes machine readable is increased.

In this embodiment, the visual expression specifications may have a showing text, but it is not to be limited to the text type and may be any configuration that is meaningful to the user.

### Embodiment 3

The main structure of the printer with built-in barcode image generating device 10, the content manager server 20, and the barcode image reading device 30 according to Embodiment 3 is substantially the same as that of Embodiment 1 and Embodiment 2 and thus detailed description thereof has been omitted, and only the method for assigning the content ID which is different from that of Embodiment 1 and Embodiment 2 will be described.

In Embodiment 1 and Embodiment 2, a corresponding content manager server 202 is assigned to the account name and then the empty regions inside the content manger server 202 are allocated and the content ID assigned, but any method may be used provided that it is a method in which ID that is formed is assigned to content B. In Embodiment 3, the content ID is assigned using the related attributes.

For example, the content manger server 202 is assigned to correspond with the price range of content B and then assigned to the empty region in content manger server 202.

In this case, the price range information for content B is used in place of “account name” in Embodiment 1 and Embodiment 2. The price range information is set to the corresponding price range by the user from the operation section 120 or the host computer 50.

As a result, the user can read the price range of content B using the barcode image and thus the barcode image can be utilized more effectively. Similarly, various information related to content B such as date, location, generator, remarks, key word, title, type of document, section of document generating, size of content and the like can be used. Also, multiple related attributes may also be combined.

The present invention was described above with reference to the embodiments, but the present invention is not to be limited by these embodiments, and as a matter of course, suitable modifications and improvements thereto are possible.

For example in the embodiments above, the barcode image generating device is built into the printer, but it may also be configured so as to be used independently. Also, the barcode image generating device may be included in another device or may be connected to a printer or external device or the like either directly or via a network. The barcode image may also be generated in a Web page or a PDF document and saved as electronic data or used and the displayed at a terminal device such as a PDA or electronic paper. There are various ways in which the barcode image can be used and thus there are also many forms for using the barcode image generating device also.

### EFFECTS OF THE INVENTION

According to the present invention, the barcode image generating device assigns a content ID in accordance with the content and the visual expression specifications are determined based on the content ID. By generating a barcode image in accordance with the visual expression specifications, a barcode image which includes suitable visual expression in accordance with the content can be generated simply.

As a result, it becomes possible for the user of the barcode to guess the results of reading the barcode in advance by observing the visual expression of the content ID designed on the barcode, and reading can be performed with a sense of assurance. In addition, the waste of performing unnecessary reading is eliminated and it becomes possible to access necessary information with more certainty.

It also becomes possible for the barcode image reading device to read a barcode image that includes a visual expression and thus by observing the visual expression of the content ID that is designed on the barcode, it becomes possible for the user of the barcode image to guess the results of reading the barcode image in advance and thus the reading can be performed with a sense of assurance. In addition, the waste of performing unnecessary reading is eliminated and it becomes possible to access necessary information with more certainty. Also the ID verification section verifies the content ID that was read at the ID reading section and a portion of the content ID that corresponds to the visual display pattern that was read by the ID portion reading section and a warning can be sent based on the results of the verification. That is to say, errors occurring in the visual expression of the barcode image can be detected and thus the reliability of the barcode image is improved and the reading can be performed with a high sense of assurance.

What is claimed is:

1. A barcode image generating device comprising:
a barcode image generating section for generating a barcode image based on content;
an ID assigning section for assigning a content ID to the content based on the content;
a machine reading specifications determining section for determining, based on the content ID, the machine reading specifications of the barcode image that is readable by the machine; and
a visual expression specifications determining section for determining, based on the content ID, visual expression specifications of the barcode image that is visually readable,
wherein the barcode image generating section generates the barcode image based on the machine reading specifications and the visual expression specifications.

2. A barcode image generating device of claim 1, wherein the ID assigning section assigns a number based on at least one of a date information, a location information, an account name information, a generator information, a description language information, a price information, a key word information, a title information, a document type information, a generation method information and a content size information to a part of numbers that the content ID comprises.

3. The barcode image generating device of claim 1, wherein the visual expression specifications comprise an information specifying a cell assigned an expression pattern as the visual expression specifications among pluralities of cells that the bar code image comprises and an attribution information assigning at least a color and a pattern to a specified cell.

4. A barcode image generating device of claim 1, wherein the content ID is a Uniform Resource Locator (URL).

5. A barcode image reading device comprising:
an ID reading section for reading a content ID from the barcode image generated based on the content ID, wherein the barcode image has an expression pattern as visual expression specifications in which a portion of the content ID is readable by viewing;
an ID portion reading section which reads the portion of the content ID from the expression pattern; and
an ID verifying section which verifies the content ID that was read by the ID reading section and a portion of the content ID that was read by the ID portion reading section and outputs a warning based on the results of the verification.

6. A barcode image generating and reading system comprising:
the barcode image generating device of claim 1; and
the barcode image reading device of claim 5.
